(19) United States
(12) Patent Application Publication
(10) Pub. No.: US 2005/0045532 A1
(43) Pub. Date: Mar. 3, 2005

(54) Deionized water filtration unit

(76) Inventor: Kuo-Chi Yen, Taichung City (TW)

Correspondence Address: Leong C. Lei;PMB#1008, 1867 Ygnacio Valley Rd., Walnut Creek, CA, 94598-3214, US

(21) Appl. No.: 10/651,971

(22) Filed: Sep. 2, 2003

(51) Int. Cl. B01D 35/143

(52) U.S. Cl. 210/85; 210/91; 210/541

(57) ABSTRACT

An improved structure of a deionized water filtration unit in a KD frame comprised of a shelf, two posts, two footings, and a face panel locked to one another allowing wall-mounting with the shelf or floor standing-alone on the floor assembly; the KD frame permitting reduced packaging volume for easier handling and lower freight; an adapter board being locked to the shelf to pool external conduits and connectors; a connector block being provided on a control box, and corresponding terminals being separately provided to each component for easy identification distinguished themselves in wording or color to facilitate DIY process for the end-user.

### BACKGROUND OF THE INVENTION

(a) Technical Field of the Invention

The present invention is related to a deionized water filtration unit, and more particularly to an improved frame and installation of a domestic deionized water filtration system

(b) Description of the Prior Art

The deionized water filtration system of the present invention relates to those water quality filtration units generally available at home or in a restaurant. Putting aside their filtration results, they present the same installation and packaging problems, essentially attributable to having its frame comprised of shelf, posts and footings integrated in one piece by welding before assembling the components (including motor, active carbon tube, reverse osmosis or sterilization unit) that consumes larger volume. As a result, a huge packaging carton is required for shipment to cause handling difficulties and higher freight. Furthermore, no alternative is available for the installation since the frame is fixed. An ample room is required for the placement and that is a problem particularly for the smaller kitchen at home. To accommodate such a big unit, the final installation location may not be the first choice. Complicate layout of pipelines and conductors layout of the filtration unit requires a professional electrician to make sure that the installed filtration unit is integral and will operate normally. Calling for the professional service also presents a major issue to the contemporary DIY life style demanding money and time saving.

### SUMMARY OF THE INVENTION

The primary purpose of the present invention is to provide an improved structure of a deionized water filtration unit that allows easy and correct DIY installation while permitting a compact size for easier handling and freight. To achiever the purpose, a KD frame including shelf, posts, footings and face panel is provided for easier handling and freight reduction while allowing alternatives for the mounting location. A connector block is provided to pool conduits and connectors to be externally connected from components of the filtration unit. All conduits and connectors as well as their corresponding terminals are precisely marked either by color or wording to facilitate DIY by the end-user.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an assembly of the present invention.

FIG. 2 is an exploded view of members of a frame of the present invention.

FIG. 3 is a schematic view showing the installation of the present invention.

FIG. 4 is a schematic view showing an alternative installation of the present invention.

FIG. 5 is a schematic view showing the connection of a control box of the present invention.

FIGS. 6A and 6B are schematic views showing the layout of those externally connected pipelines and connectors of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

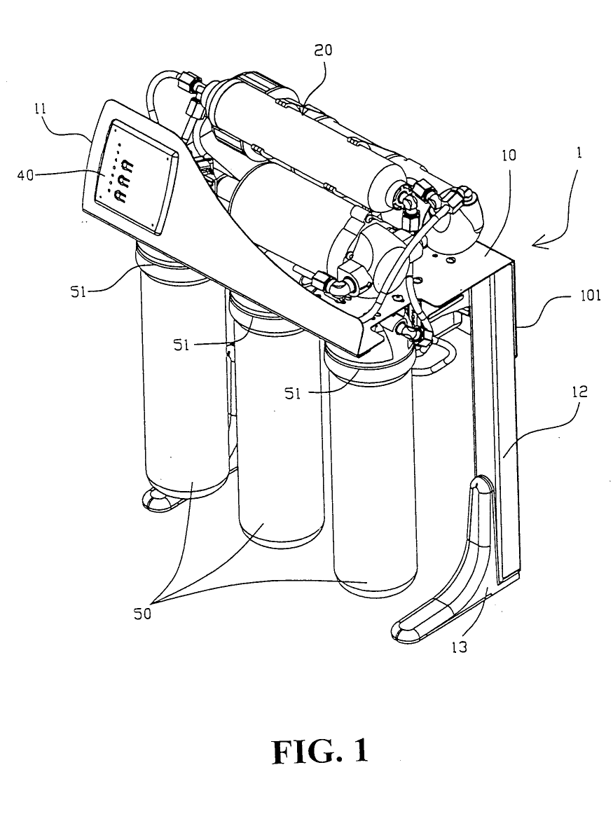

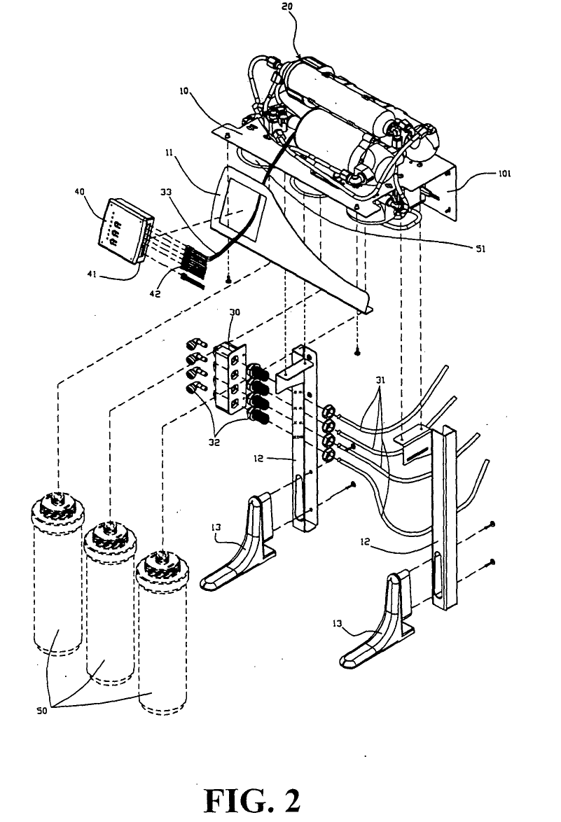

Referring to FIGS. 1 and 2, a frame 1 of a preferred embodiment of the present invention is essentially comprised of a shelf 10, a penal 11, two posts 12 and two footings 13. The shelf 10 related to a horizontal plate is provided at its front multiple locking holes to be fastened to the face panel 11 with multiple screws, and the rear of the shelf 10 is folded downward for 90 degrees to define a locking board 101 whereon multiple locking holes are provided to be fastened to both posts 12. All main components 20 of the filtration unit have been locked in position ex-factory. Multiple locking lids 51 are provided below the shelf 10 to hold corresponding filtration cartridges 51 in position for the frame to be provided with all filtration supplies all locked in position before leaving the plant. The approximately L-shaped face panel 11 has a folded edge at a right angle whereon top multiple locking holes for the face panel 11 to be fastened to the shelf 10, and a control box 40 connected to multiple conductors 33 from the main components 20 is provided on the elevation of the face panel 11 to monitor the function or optional operation items of each main component. Both posts 12 are respectively locked to both sides of the shelf 10 and the length of each post 12 must be longer than that of the filtration cartridge 51 locked to the locking lid 51. At where appropriately on the upper and the lower sections of the post 12 multiple locking holes are provided to be fastened with screws to the locking board 101 of the shelf 10 and to the footing 13. The footing 13 is made in a wedge shape comprised of an elevated part 131 provided with multiple locking holes to be fastened to the post 12, and a flat part 132 to be firmly rest on the floor. The connector block 30 locked to the frame 1 or elsewhere as appropriately pools and holds in position all those conduits 31 and connectors 32 adapted to those pipelines to be externally connected to all the main components 20 that are locked to the shelf 10. The connector block 30 is marked with wording or all conduit connectors are distinguished among themselves by color to facilitate easy assembly of those external pipelines.

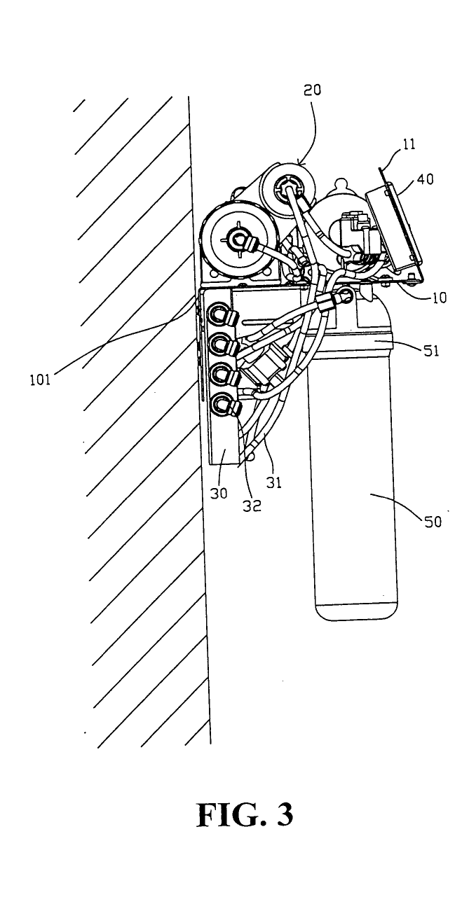

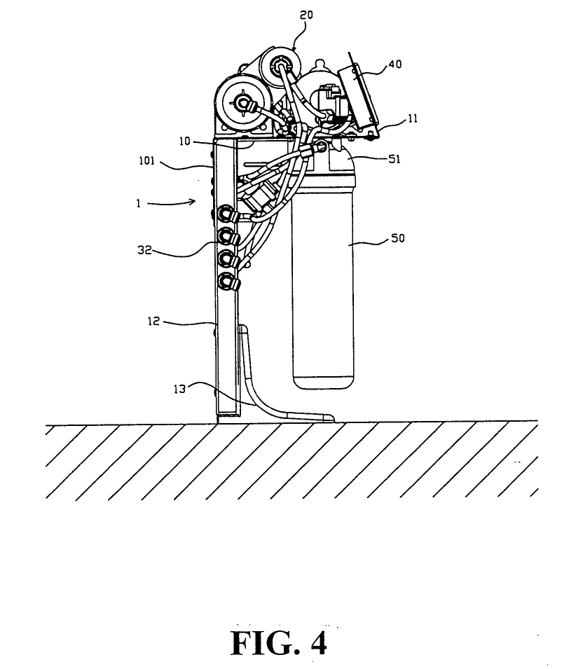

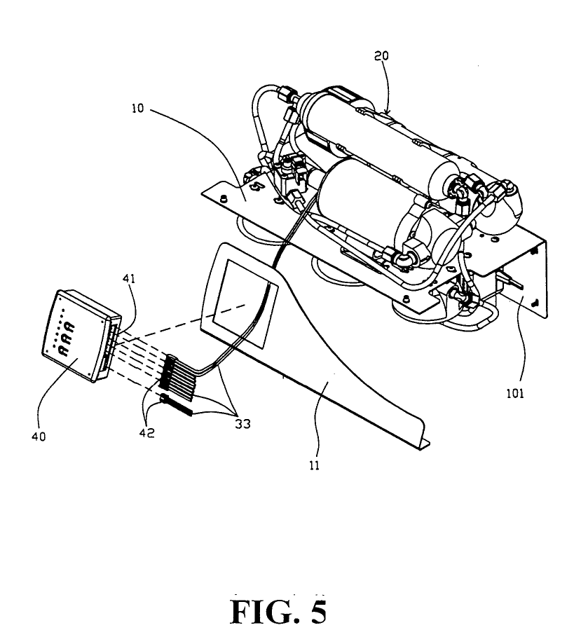

As illustrated in FIGS. 3 and 4, the KD frame 1 of the present invention while being compact skips the installation of the posts and the footings in case of wall-mounting mode is selected. Wherein, the locking board 101 of the shelf 10 is forthwith mounted on the wall; or alternatively in case of standing-alone mode, those two posts 12 and two footings are also used. Now referring to FIG. 5, multiple terminal blocks 41 integrated and aligned in good order are provided on one side of the control box on the face panel 11. Each conductor 33 of the main component 20 is provided with a terminal 42. All pairs of the terminal blocks 41 and terminals 42 are marked either by wording or color to distinguish among themselves for the end-user to correctly plug in.

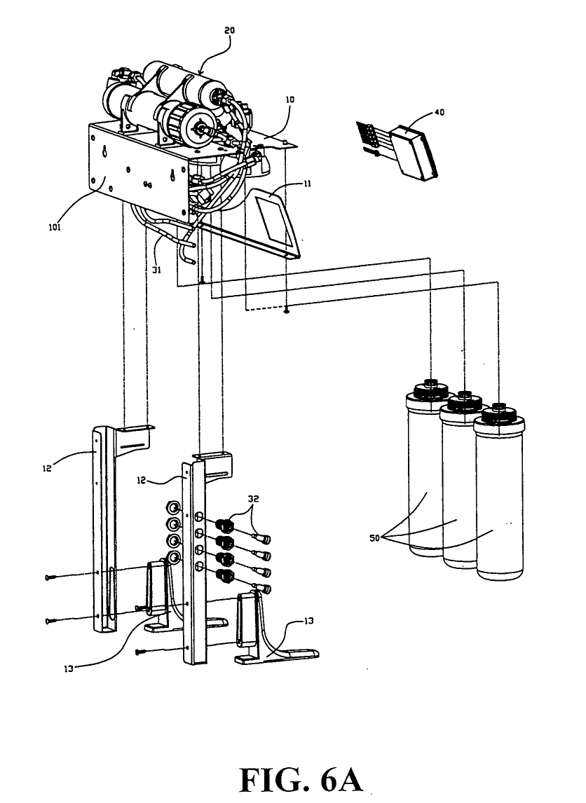

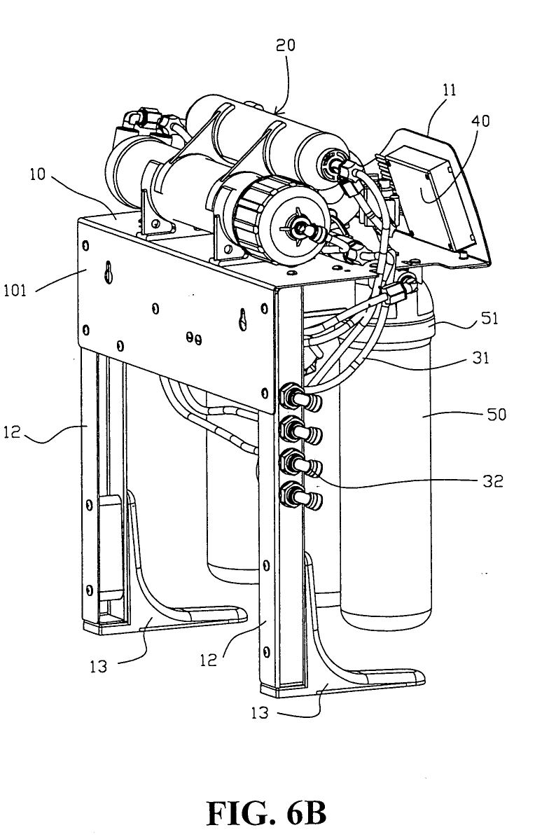

As illustrated in FIGS. 6A and 6B, one post 12 is selected to be provided with multiple positioning holes identified by wording or color to facilitate the plug-in by those conduits 31 and connectors 32 externally connected to corresponding main components 20.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An improved structure of a deionized water filtration unit is essentially comprised of a shelf, a penal, two posts and two footings; wherein, the shelf related to a horizontal plate, all main components of the filtration unit being locked onto the shelf ex-factory, multiple locking holes being provided at its front to be fastened to the face panel with multiple screws; the rear of the shelf being folded downward for 90 degrees to define a locking board whereon multiple locking holes being provided to be fastened to both posts; the L-shaped face panel having a folded edge at a right angle whereon top multiple locking holes for the face panel to be fastened to the shelf, a control box being provided on the panel to be connected to multiple conductors from the main components; panel to monitor the function or optional operation items of each main component; multiple connection holes being provided on the upper and lower sections of each of both posts to be respectively locked with screws to both sides of the shelf; and the footing being made in a wedge shape comprised of an elevated part provided with multiple locking holes to be fastened to the post.

2. An improved structure of a deionized water filtration unit as claimed in claim 1, wherein, a connector block is separately locked to the frame to pool and hold in position all those conduits and connectors adapted to those pipelines to be externally connected to all the main components that are locked to the shelf; and each of conduits and connectors is provided with an external connector.

3. An improved structure of a deionized water filtration unit as claimed in claim 1, wherein, multiple terminal blocks integrated and aligned in good order are provided on one side of the control box on the face panel, and each conductor of the main component is provided with a terminal to plug in respective connector block.
